(19) United States
(12) Patent Application Publication
(10) Pub. No.: US 2024/0087068 A1
(43) Pub. Date: Mar. 14, 2024

(54) SYSTEMS AND METHODS FOR AUTOMATICALLY RECOMMENDING ACADEMIC PROGRAMS

(71) Applicant: Applyboard Inc., Kitchener (CA)

(72) Inventor: Haitham AMAR, Kitchener (CA)

(21) Appl. No.: 18/465,676

(22) Filed: Sep. 12, 2023

Related U.S. Application Data
(60) Provisional application No. 63/406,668, filed on Sep. 14, 2022.

(51) Int. Cl. G06Q 50/20

(52) U.S. Cl. CPC G06Q 50/2053

(57) ABSTRACT

Various methods and systems for automatically recommending academic programs for an applicant are disclosed herein. The systems and methods disclosed herein can involve receiving initial applicant data, applying a historical applicant data model to define an applicant profile for the applicant, applying an employment outlook data model to each initial academic program included in the initial applicant data to generate an employment success score, determining whether the employment success score for each academic program is below a threshold and in response to determining that the employment success score for an initial academic program is below the threshold, applying an employment recommendation data model to recommend employment types and applying an institution success data model to each recommended employment type to identify academic institutions offering relevant academic programs, and identifying at least one of the one or more relevant academic programs and initial academic programs as program recommendations.

### CROSS-REFERENCE TO RELATED APPLICATIONS

This application claims the benefit of U.S. Provisional Application No. 63/406,668, filed on Sep. 14, 2022. The content of U.S. Provisional Application No. 63/406,668 is hereby incorporated by reference in its entirety.

### FIELD

The described embodiments generally relate to academic program advisory systems for automatically recommending academic programs for an applicant, and methods of operating thereof.

### BACKGROUND

When an applicant is applying to academic programs outside of a local or traditional system, the application process can be complicated or difficult due to unexpected factors and/or factors unique to the foreign jurisdiction or academic program. For example, an applicant looking to apply to education programs in another country may not be familiar with foreign study requirements and/or timelines, or eligibility requirements. Also, applicants applying to enter post-secondary and/or professional schools may need to choose an academic program in which to specialize. Depending on the life experience of the applicant, the selection of the academic programs may be driven by their personal interests and/or what they perceive to likely lead to later success in life. Many applicants associate success with employment likelihood following completion of the academic program.

To assist with their decision-making, applicants are often guided by advice from family, friends, and/or academic advisors, and information available from the academic institutions and/or online resources (e.g., blogs, forums, etc.). Unfortunately, much of the advice and information is limited to their social circle and geographical location and do not specifically consider the applicant's circumstance. The information may not always be reliable or current since many requirements in the application process are subject to change with minimal to no notice.

### SUMMARY

The various embodiments described herein generally relate to academic advisory systems for recommending academic programs for an applicant and methods of operating thereof.

In accordance with an example embodiment, there is provided an academic program advisory system for automatically recommending one or more academic programs for an applicant. The system includes a processor configured to: receive, from the applicant, an initial applicant data comprising one or more initial academic programs; apply a historical applicant data model to the initial applicant data to define an applicant profile for the applicant, the applicant profile associating the applicant to one or more predefined applicant profiles defined by the historical applicant data model; apply an employment outlook data model to each initial academic program and the applicant profile to generate an employment success score for the applicant in that initial academic program; determine whether the employment success score assigned to each initial academic program is below an employment success threshold; in response to determining that an initial academic program is associated with the employment success score below the employment success threshold, apply an employment recommendation data model to the applicant profile to recommend one or more recommended employment types for the applicant; and apply an institution success data model to each recommended employment type and the applicant profile to identify one or more academic institutions offering one or more relevant academic programs for preparing the applicant for that recommended employment type, identify at least one of the one or more relevant academic programs and the one or more initial academic programs associated with the employment success score above the employment success threshold as the one or more academic programs recommended for the applicant.

In some embodiments, the processor is further configured to: apply the historical applicant data model to assign the applicant a profile match score with each predefined applicant profile of the one or more predefined applicant profiles; and define the applicant profile based on the one or more predefined applicant profiles assigned the profile match score above a profile score threshold.

In some embodiments, the processor is further configured to, in response to determining that the initial academic program is associated with the employment success score below the employment success threshold: display the employment success score associated with each initial academic program to the applicant; request additional applicant data from the applicant prior to applying the employment recommendation data model to recommend the one or more recommended employment types for the applicant; and apply the historical applicant data model to the additional applicant data and the initial applicant data to update the applicant profile.

In some embodiments, the processor is further configured to: apply the employment recommendation data model to determine the one or more recommended employment types by assigning an employment match score to one or more initial employment types based at least on the applicant profile; and select the one or more initial employment types assigned the employment match score above an employment match threshold as the one or more recommended employment types.

In some embodiments, the processor is further configured to: the processor is further configured to: apply the employment recommendation data model to the applicant profile and the one or more initial academic programs to recommend the one or more recommended employment types for the applicant.

In some embodiments, the processor is further configured to: apply the institution success data model to each initial academic program to identify one or more initial academic institutions offering that initial academic program with a program success score above a program success threshold.

In some embodiments, the program success score relates to an employment success following completion of the initial academic program at that initial academic institution.

In some embodiments, the processor is further configured to: continuously receive further applicant data from the applicant; and automatically updates the recommended one or more academic programs for the applicant.

In some embodiments, the initial applicant data comprises personal data related to the applicant.

In accordance with an embodiment, there is provided a method for automatically recommending one or more academic programs for an applicant. The method includes operating a processor to: receive, from the applicant, an initial applicant data comprising one or more initial academic programs; apply a historical applicant data model to the initial applicant data to define an applicant profile for the applicant, the applicant profile associating the applicant to one or more predefined applicant profiles defined by the historical applicant data model; apply an employment outlook data model to each initial academic program and the applicant profile to generate an employment success score for the applicant in that initial academic program; determine whether the employment success score assigned to each initial academic program is below an employment success threshold; in response to determining that an initial academic program is associated with the employment success score below the employment success threshold, apply an employment recommendation data model to the applicant profile to recommend one or more recommended employment types for the applicant; and apply an institution success data model to each recommended employment type and the applicant profile to identify one or more academic institutions offering one or more relevant academic programs for preparing the applicant for that recommended employment type, identify at least one of the one or more relevant academic programs and the one or more initial academic programs associated with the employment success score above the employment success threshold as the one or more academic programs recommended for the applicant.

In some embodiments, the method includes operating the processor to: apply the historical applicant data model to assign the applicant a profile match score with each predefined applicant profile of the one or more predefined applicant profiles; and define the applicant profile based on the one or more predefined applicant profiles assigned the profile match score above a profile score threshold.

In some embodiments, the method further includes operating the processor to, in response to determining that the initial academic program is associated with the employment success score below the employment success threshold: display the employment success score associated with each initial academic program to the applicant; request additional applicant data from the applicant prior to applying the employment recommendation data model to recommend the one or more recommended employment types for the applicant; and apply the historical applicant data model to the additional applicant data and the initial applicant data to update the applicant profile.

In some embodiments, the method includes operating the processor to: apply the employment recommendation data model to determine the one or more recommended employment types by assigning an employment match score to one or more initial employment types based at least on the applicant profile; and select the one or more initial employment types assigned the employment match score above an employment match threshold as the one or more recommended employment types.

In some embodiments, the method includes operating the processor to further configured to: the processor is further configured to: apply the employment recommendation data model to the applicant profile and the one or more initial academic programs to recommend the one or more recommended employment types for the applicant.

In some embodiments, the processor is further configured to: apply the institution success data model to each initial academic program to identify one or more initial academic institutions offering that initial academic program with a program success score above a program success threshold.

In some embodiments, the program success score relates to an employment success following completion of the initial academic program at that initial academic institution.

In some embodiments, the method includes operating the processor to: continuously receive further applicant data from the applicant; and automatically updates the recommended one or more academic programs for the applicant.

In some embodiments, the initial applicant data comprises personal data related to the applicant.

In accordance with an embodiment, there is provided an academic program advisory system for automatically recommending one or more academic programs for an applicant. The system includes a processor configured to: receive, from the applicant, an initial applicant data comprising one or more initial academic programs; apply a historical applicant data model to the initial applicant data to define an applicant profile for the applicant, the applicant profile associating the applicant to one or more predefined applicant profiles defined by the historical applicant data model; apply an employment outlook data model to each initial academic program and the applicant profile to generate an employment success score for the applicant in that initial academic program; determine whether the employment success score assigned to each initial academic program is below an employment success threshold; in response to determining that an initial academic program is associated with the employment success score below the employment success threshold, request additional applicant data from the applicant for updating the initial applicant profile; apply the historical applicant data model to the additional applicant data and the initial applicant data to update the applicant profile; and apply the employment outlook data model to each initial academic program and the updated applicant profile to update the employment success score for the applicant in that initial academic program; and identify one or more academic programs from the one or more initial academic programs to recommend to the applicant based on the employment success score.

In some embodiments, the processor is further configured to: identify the one or more initial academic programs associated with the employment success score above an employment success threshold as the one or more academic programs recommended for the applicant.

In some embodiments, the processor is further configured to: in response to determining that none of the one or more initial academic programs is associated with the employment success score above the employment success threshold, identify one or more acceptable initial academic programs from the one or more initial academic programs as the one or more academic programs recommended for the applicant, the one or more acceptable initial academic programs being the one or more initial academic programs associated with an acceptable employment success score, otherwise, requesting further applicant data from the applicant for updating the applicant profile.

In some embodiments, the processor is further configured to: determine one or more application data relevant to the one or more initial academic programs that is absent from the initial applicant data; and include the one or more application data in the additional applicant data requested from the applicant.

In some embodiments, the processor is further configured to: display the employment success score associated with each initial academic program to the applicant.

In accordance with an embodiment, there is provided a method for automatically recommending one or more academic programs for an applicant. The method includes operating a processor to: receive, from the applicant, an initial applicant data comprising one or more initial academic programs; apply a historical applicant data model to the initial applicant data to define an applicant profile for the applicant, the applicant profile associating the applicant to one or more predefined applicant profiles defined by the historical applicant data model; apply an employment outlook data model to each initial academic program and the applicant profile to generate an employment success score for the applicant in that initial academic program; determine whether the employment success score assigned to each initial academic program is below an employment success threshold; in response to determining that an initial academic program is associated with the employment success score below the employment success threshold, request additional applicant data from the applicant for updating the initial applicant profile; apply the historical applicant data model to the additional applicant data and the initial applicant data to update the applicant profile; and apply the employment outlook data model to each initial academic program and the updated applicant profile to update the employment success score for the applicant in that initial academic program; and identify one or more academic programs from the one or more initial academic programs to recommend to the applicant based on the employment success score.

In some embodiments, the method includes operating the processor to: identify the one or more initial academic programs associated with the employment success score above an employment success threshold as the one or more academic programs recommended for the applicant.

In some embodiments, the method includes operating the processor to: in response to determining that none of the one or more initial academic programs is associated with the employment success score above the employment success threshold, identify one or more acceptable initial academic programs from the one or more initial academic programs as the one or more academic programs recommended for the applicant, the one or more acceptable initial academic programs being the one or more initial academic programs associated with an acceptable employment success score, otherwise, requesting further applicant data from the applicant for updating the applicant profile.

In some embodiments, the method includes operating the processor to: determine one or more application data relevant to the one or more initial academic programs that is absent from the initial applicant data; and include the one or more application data in the additional applicant data requested from the applicant.

In some embodiments, the method includes operating the processor to: display the employment success score associated with each initial academic program to the applicant.

In accordance with some embodiments, there is provided a non-transitory computer-readable medium having instructions executable on a processor for implementing any one of the methods disclosed herein.

### BRIEF DESCRIPTION OF THE DRAWINGS

Several embodiments will be described in detail with reference to the drawings, in which:

FIG. 1 is a block diagram of an example academic program advisory system;

FIG. 2 is a flowchart of a method for recommending academic programs for an applicant in accordance with an example embodiment;

FIG. 3 shows a graphical user interface illustrating an example embodiment of an application of the academic program advisory systems described herein;

FIG. 4 shows a graphical user interface illustrating another example embodiment of an application of the academic program advisory systems described herein;

FIG. 5 shows a graphical user interface illustrating another example embodiment of an application of the academic program advisory systems described herein;

FIG. 6 shows a graphical user interface illustrating another example embodiment of an application of the academic program advisory systems described herein;

FIG. 7 is a flowchart of a method for recommending academic programs for an applicant in accordance with another example embodiment; and

FIG. 8 shows a graphical user interface illustrating another example embodiment of an application of the academic program advisory systems described herein.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to academic program advisory systems and associated methods of operating the systems.

The academic program into which an applicant enrolls and subsequently completes can have a long-term impact on the future success of that applicant. Whether the applicant is selecting an academic program outside of a local or traditional system, or at a post-secondary or professional institution, that academic program can significantly influence the applicant's overall success likelihood in the future. For many applicants, success is often defined by an employability of that applicant after completing that academic program.

The traditional process in which an applicant selects an academic program is generally based on word-of-mouth advice on the academic programs, or academic institutions generally and/or information available via online resources. Oftentimes, applicants can be persuaded to enroll into certain academic programs due mostly to the associated popularity without really considering the practical usefulness of that academic program in the long term. Also, there may be agreements between certain academic institutions and the school of the applicant which may result in more direct advertisements for those academic institutions within the school setting. Unfortunately, the traditional process does not consider the specific circumstances of that applicant. Also, the information may be unreliable and inaccurate.

Oftentimes, applicants face considerable risks associated with the selected academic programs as applicants cannot properly gauge their success likelihood following completion of that academic program or completion of the academic program at that specific academic institution. Attending academic programs involve significant financial and time investment by the applicant and so, an academic program that is unlikely to lead to that applicant's future success can have detrimental consequences. The detrimental consequence can be magnified when that applicant has limited financial resources.

When selecting academic programs, most applicants conduct independent research on the academic programs and the academic institutions. However, applicants typically limit the scope of their research to institutions and/or academic programs with which they have some familiarity. These academic institutions are typically those local to the applicant's geographical region, internationally known academic institutions, academic institutions that have been attended, or academic programs completed by those they know personally. Applicants may also refer to third-party lists identifying potential academic institutions, but these third-party lists are unlikely to be comprehensive or specific to that applicant's circumstances, and may be biased (e.g., due to sponsorships, etc.) or contain inaccurate information. Unfortunately, however thorough the research is done, it may be futile as the applicant may be ineligible for or have a low chance of acceptance into the academic programs due to factors that are not advertised or well-known (e.g., requirements unique to a foreign jurisdiction, etc.).

In some instances, applicants can consult with academic advisors to obtain assistance in identifying suitable academic programs. While these advisors may be more knowledgeable about specific academic programs and academic institutions, the experience of these advisors may also be limited to specific academic institutions local to their geography, academic programs in which they specialize, or past enrollment experience. The advisors may not be able to offer a comprehensive perspective specific to that applicant based on information beyond those experiences, such as the success of past applicants beyond the enrollment point. In general, applicants often select academic programs with minimal insight on which academic programs are associated with success following completion of the program, and further, success likelihood at that specific academic institution. Success, as noted, is often associated with employment likelihood but, in some cases, success can be measured differently.

The systems and methods disclosed herein offer automatic recommendations on academic programs to applicants based on data relevant to the applicant's circumstances. These recommendations can offer valuable insight to the application process for the applicants.

In some embodiments, the academic program advisory systems disclosed herein can automatically recommend academic programs for an applicant by applying data models to applicant data. The academic program advisory system can generate data models based at least on historical employment success of past applicants. For example, the academic program advisory system can apply a historical applicant data model to the applicant data to associate the applicant with one or more predefined applicant profiles to define an applicant profile for the applicant. The applicant data can relate to academic programs identified by the applicant and/or personal information associated with the applicant. The academic program advisory system can generate the predefined applicant profiles based on information related to past applicants. For example, the academic program advisory system can define the applicant profile by determining a measure of similarity between the characteristics of the applicant and the predefined applicant profiles. The academic program advisory system can also generate an employment outlook data model based at least on historical employment data related to past applicants. The academic program advisory system can apply the employment outlook data model to the one or more academic programs selected by the applicant and generate an employment success score for the applicant for each academic program.

The employment success score can represent that specific applicant's employment likelihood following completion of the associated academic program. The employment success score can assist the applicant with deciding which academic program to pursue based on relevant historical information specific to the applicant.

As will be described in further detail below, in some embodiments, the academic program advisory system can apply an employment recommendation data model to the applicant profile to recommend employment types if the employment success score assigned to an academic program is below an employment success threshold. In some embodiments, the academic program advisory system can display to the applicant the academic programs that satisfy the employment success threshold. The academic programs may include the academic programs initially identified by the applicant that has been assigned an employment success score above the employment success threshold, and/or academic programs recommended separately by the academic program advisory system that is associated with the employment success score above the employment success threshold.

In some embodiments, as will be described in further detail below, the academic program advisory system can apply an institution success data model to identify academic institutions offering academic programs that are likely to successfully prepare the applicant for the recommended employment types. The academic program advisory system can generate the employment recommendation data model and the institution success data model based on relevant historical data.

In some embodiments, the academic program advisory system can request additional applicant data from the applicant. The academic program advisory system can then update the applicant profile with at least some of the additional applicant data.

The academic program advisory systems described herein can be dynamic, that is, they can continuously update the recommendations based on additional data without a manual request from the applicant. For example, the academic program advisory systems can continuously update the various data models and update the results accordingly (e.g., the applicant profile may be updated based on updated data models), and/or the academic program advisory systems can receive updated and/or additional applicant data and apply that accordingly to update the recommendations and/or applicant data.

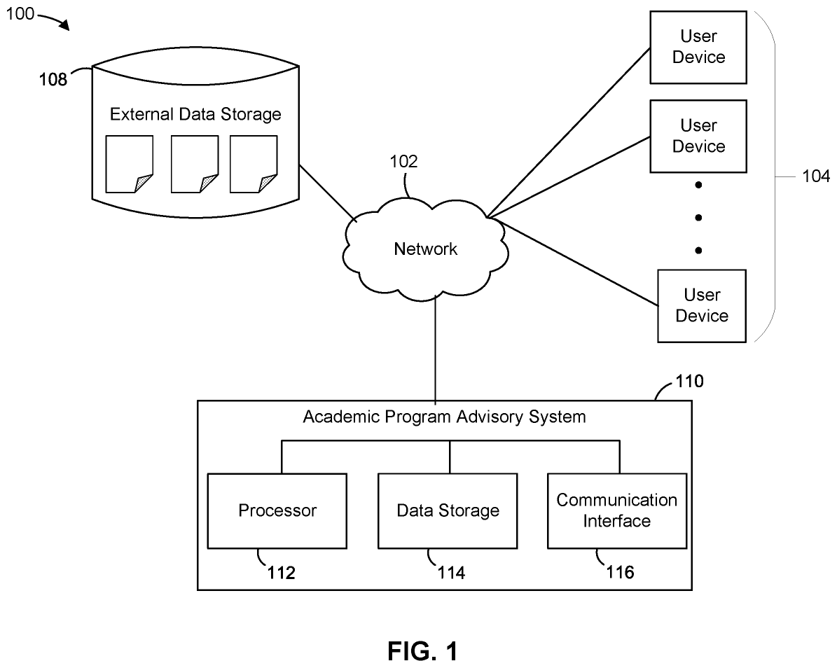

Reference is now made to FIG. 1, which shows a block diagram 100 of an example academic program advisory system 110 in communication with a user device 104 and an external data storage 108 via a network 102. For illustration purposes, multiple user devices 104 are illustrated in FIG. 1. It is understood that one or more user devices 104 can be used with the academic program advisory system 110 disclosed herein. The academic program advisory system 110 can communicate with the user device 104 and the external data storage 108 over a wide geographic area via the network 102.

The academic program advisory system 110 includes a processor 112, a data storage 114 and a communication interface 116. The academic program advisory system 110 can be implemented with more than one computer server distributed over a wide geographic area and connected via the network 102. The processor 112, the data storage 114 and the communication interface 116 may be combined into a fewer components or may be separated into further components. The academic program advisory system 110 can include other components, in some embodiments.

The processor 112 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the academic program advisory system 110. The processor 112 can include more than one processor and each processor can be configured to perform different dedicated tasks.

The communication interface 116 can include any interface that enables the academic program advisory system 110 to communicate with various devices and other systems. For example, the communication interface 116 can receive input data from a user device 104 or data from the external data storage 108 and process the data and/or receive input data from the user device 104 and store the data in the data storage 114 or the external data storage 108. The communication interface 116 may also include at least one of an Internet, Local Area Network (LAN), Ethernet, Firewire, modem or digital subscriber line connection. Various combinations of these elements may be incorporated within the communication interface 116.

The data storage 114 can include RAM, ROM, one or more hard drives, one or more flash drives or some other suitable data storage elements such as disk drives, etc. The data storage 114 can, for example, include a memory unit used to store programs and an operating system used by the academic program advisory system 110. For instance, the operating system provides various basic operational processes for the operator unit. The programs include various user programs so that a user can interact with the academic program advisory system 110, but not limited to, viewing and manipulating data as well.

The data storage 114 may further include one or more databases (not shown in FIG. 1) for storing information related to, for example users, applicants, previous applicants, academic advisors, agents, academic institutions, academic programs and employment types. The information can be stored on one database or separated into multiple databases. The data storage 114 may also store data models that define the relationships between different data sets. The information and data models may be stored also in the external data storage 108 as a backup storage solution, or some portions of the information and data models may be stored remotely in the external data storage 108 and accessed by the academic program advisory system 110 as needed.

Information related to a user that may be stored in the data storage 114 may include, but not limited to, general information about the user that may typically be stored in a user profile, including personal information (e.g., name, birthdate, contact information, etc.), a type of user (e.g., an applicant, an agent for an applicant, etc.), and a login identifier and password for accessing the academic program advisory system 110. The user of the academic program advisory system 110 may be an applicant. The information that can be stored in respect of the applicant can include, but is not limited to, nationality, education background, grades, and foreign study permit availability. The information in respect of the applicant may be accessible by an agent acting on behalf of the applicant. The users of the academic program advisory system 110 may include past applicants who have gone through the application process. The information stored in respect of these past applicants can include, but not limited to, the information stored in respect of applicants generally, information related to the academic program(s) and academic institution(s) to which the previous applicants sought entry, the results of the application to those academic program(s) and academic institution(s), the applicant's status and progress within the academic program(s) and any relevant employment following completion of the academic program(s). The information associated with the users may also be retrieved from external data sources, including publicly available data sources and/or from academic institutions.

Information related to institutions that may be stored in the data storage 114 may include, but not limited to, an academic level or type (e.g., university, college, high school, public or private, etc.), a geographical location, notable features or offerings, key statistical data (e.g., average cost of living, average tuition, average length of program, application fee, top disciplines, etc.) and available academic programs. Information related to academic programs that may be stored in the data storage 114 may include, but not limited to, tuition fee, application fee, a program length and key statistics, such as typical acceptance statistics. Information related to employment types that may be stored in the data storage 114 may include, but not limited to, typical entry requirements (e.g., minimal education level or academic program, etc.) and average salary.

The data models stored in the data storage 114 and/or the external data storage 108 may include data models helpful for recommending academic program(s) for the applicant. The data models can be generated by the academic program advisory system 110 or by an external system. The data models can be generated using various machine learning techniques for correlating different types of data to assist with the operation of the academic program advisory system 110.

Generally, after the relevant data is collected, features that are mostly likely to be impacted are identified based on subject matter expertise. The data that is needed for a successful result is also considered. In some embodiments, the academic program advisory system 110 can visualize the collected data to verify separability of the classes (e.g., for classification) using various data visualization techniques, such as but not limited to principal component analysis (PCA) and t-distributed stochastic neighbor embedding (t-SNE). This can help with inferring whether there is a path for the problem to be solved or not with the data available.

For example, to develop the historical applicant data model, the academic program advisory system 110 can consider the historical applicant data available, which includes the initial applicant profile and any other data added during the applicant's application journey (e.g., An applicant enters generic data initially as expected by most academic institutions. Depending on the academic institutions' more specific requirements, the applicants will enter further data.). When the academic program advisory system 110 develops the machine learning models in respect of the applicants, academic institutions and academic programs, the academic program advisory system 110 can operate to standardize the data (e.g., the different language exam scores, the different GPA coding, grading and levels, the different prior study degree levels, etc.). This can help identify any data collection gaps and initiate necessary remedies. In some embodiments, the academic program advisory system 110 can also augment data sets with other data sets to ensure data models are not biased towards the applicants received by the academic program advisory system 110. For example, the academic program advisory system 110 may augment data related to foreign permit probability of its users with external data, such as government-based data, to ensure the data models are not built biased towards the users of the academic program advisory system 110.

The features identified can be evaluated by the academic program advisory system 110 with various different techniques, such as but not limited to, variance thresholding technique (due to the sparsity of the data for the data models used by the academic program advisory system 110, various thresholding was not very effective), recursive feature elimination technique (this can be used by the academic program advisory system 110 to assign importance to the features based on various other supervised learning algorithms), and/or decision tree technique (this can also be used by the academic program advisory system 110 to assign importance to the features based on various other supervised learning algorithms, especially for applicant-related data models). Decision tree technique can be beneficial due at least to the visualization capability and can explain the feature impact.

Different methods of building the data models may be applied. For example, one option involves operating the academic program advisory system 110 to build data models on individual datasets and to apply averaging or voting for the final result. In another example, the academic program advisory system 110 can merge the various relevant datasets (e.g., by stacking since individual records cannot be joined together) and build one data model on the merged dataset. In some embodiments, the academic program advisory system 110 can limit the dataset to a specific number of features such that merging the datasets can result in missing values. The missing values can, in some embodiments, be treated by the academic program advisory system 110 as a separate category, instead of filling with the most popular category.

Various machine learning techniques can be applied for generating the data models disclosed herein, such as but not limited to, decision tree technique, random forest technique, linear discriminant analysis (LDA) technique, logistic regression technique, support vector machine (SVM) technique, and k-nearest neighbor (kNN) technique.

A binary decision tree splits into two paths at each factor and continues in this manner until a classification is reached. The stopping point can be based on the depth of the tree or the accuracy of the final leaf. Decision trees provide a classification but do not provide a method for determining the probability of the accuracy of the prediction. In addition, it can often have lower accuracy than some of the other methods disclosed herein. For at least these reasons, a decision tree is unlikely to be the optimal solution for evaluating an applicant's likelihood of acceptance into an academic institution by the academic program advisory system 110.

Random forest is a method that utilizes many decision trees in an ensemble method. Each decision tree in the ensemble predicts a class and the class with the most votes becomes the prediction. This model has high potential for this problem. The binary variables such as nationality perform well in a decision tree as a splitting factor. The use of decision trees in an ensemble also allows for a class probability based on the predictions from the various trees, despite the unprincipled nature of this probability estimation. The academic program advisory system 110 can apply random forest technique to determine a score range for example.

LDA is a dimensionality reduction technique that projects the data to a lower dimension to maximize class separability. LDA can also be used as a classification method (which can be applied by the academic program advisory system 110 in the various methods disclosed herein). It will be highly accurate if the data is linearly separable but requires the data to be normally distributed. Since there are many categorical factors in the dataset being analyzed by the academic program advisory system 110, LDA may not be suitable for the academic program advisory system 110 to use for developing data models.

Logistic regression is a statistical technique used to estimate probabilities of a binary categorical response based on one or many independent variables. For example, it could be used to estimate the probability of an applicant being accepted (e.g., ‘1’) or not accepted (e.g., ‘0’). The model coefficients are determined by utilizing maximum likelihood estimation. Since logistic regression will give a probability estimate and does not require the underlying data to be linear, this technique may be suitable for the academic program advisory system 110 to use for developing data models.

SVM is a classification algorithm that separates classes by a hyperplane. There are different kernel types that can be used depending on whether the data is linear or non-linear, making the algorithm very versatile. It is also very effective in high dimensional spaces. It does not perform as well if the dataset is noisy and the target classes are overlapping. For generating applicant profiles, SVMs do not directly provide probability estimates but they can be obtained using five-fold cross-validation. However, obtaining the probability estimates can be very computationally expensive on large datasets as it is done using Platt scaling. In addition, the probability estimates may be inconsistent with the classification. Given these caveats, SVM is unlikely suitable for the academic program advisory system 110 to use for developing data models.

The kNN algorithm works by classifying a new data point based on the majority class of the k closest neighbours. Rather than constructing an algorithm, kNN stores instances of the training data. As a result, it can be slow on large datasets as it is calculating the distance between each point. In addition, using kNN classifiers do not output probabilities but the ratio of neighbours voting for the class relative to the total neighbours could be used to obtain an evaluation of the applicant.

In some embodiments, the academic program advisory system 110 can train a historical applicant data model using historical applicant information to define one or more different predefined applicant profiles for representing past applicant information. The historical applicant data model can then be applied to the applicant data to characterize that applicant with respect to the predefined applicant profiles. For example, each predefined applicant profile can be defined in accordance with varying degrees of different applicant characteristics (e.g., a nationality, an education country, an education level, a grading scheme, an English exam type, an academic program of interest or most often selected by the applicants, historical applicant data, etc.). Example machine learning models that can be applied to the past applicant information can include, but is not limited to, to a random forest regression model.

The academic program advisory system 110 can, in some embodiments, train an employment outlook data model based on employment results of the past applicants as well as employment results of students who completed an associated academic program. The employment outlook data model can characterize relationships between various academic programs and a corresponding likelihood of employment following completion of that academic program, as well as the type of employment. The employment outlook data model can consider employment likelihood following completion of an academic program regardless of academic institution and also completion of the academic program at specific academic institutions. For example, the completion of an academic program at two different institutions can lead to different employment prospects. The employment outlook data model can also be trained to correlate employment likelihood with the various predefined applicant profiles as different applicants may experience different employment likelihood despite attending the same academic program offered at the same academic institution.

The academic program advisory system 110 can train an employment recommendation data model using past applicant information and their resulting employment types to assist with offering employment type recommendations to the applicant. The employment recommendation data model may be generated, in part, based on data associated with students who completed relevant academic programs but did not use the academic program advisory system 110.

The academic program advisory system 110 can train an institution success data model using past data related to an applicant's employment success following completion of an academic program offered at an academic institution. For example, the institution success data model can define associations between academic programs and resulting employment types following completion of that academic program.

Other data models can similarly be applied by the academic program advisory system 110 to assist with recommending the academic programs. For example, other data models can relate to data associated with an acceptance probability of an applicant by an academic institution or academic program (e.g., student quality data model), and a foreign permit probability of an applicant in obtaining the necessary visas or student permits for attending an academic institution. The student quality data model needs to produce a score which should be the probability that the student will both get accepted to any academic institution, including visa acceptance. In terms of the model types to use, both regression and classification could be used. For regression, approval rate will be predicted directly. For classification, the target would be the most probable outcome (approve or refuse). Some classification models also have the ability to have the probability of each class as the output.

For the student quality scoring model, it appears that random forest technique is more suited for the dataset followed by kNN technique and logistic regression technique. The performance of these models was determined in absence of hyper parameter tuning since the tuning process is time consuming and not suitable for the initial screening phase. Logistic regression was suitable for the problem due to the need to have a probabilistic output. However, the implementation was challenging due the problem's non-linear nature. LR is a generalized linear model, the problem, as per our component analysis, does not seem to lend itself well to linear models. kNN deals with the non-linearity problem, but presents challenges with managing overfitting. While kNN is a powerful algorithm that does not suffer from bias at k=1, the model tends to overfit. As the value of k is increased, more bias is introduced to the model. Random forest technique, on the other hand, is resilient to overfitting while maintaining low bias.

The user device 104 can include any computing device that is capable of receiving an input from a user and communicating with the academic program advisory system 110 via the network 102. The user device 104 may communicate with the network 102 through a wired or wireless connection. In some embodiments, the connection request initiated from the user device 104 may be initiated from a web browser and directed at a browser-based communications application on the academic program advisory system 110.

The user device 104 can include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. The user device 104 can also include a communication interface that can receive input from various input devices, such as a mouse, a keyboard, a touch screen, a thumbwheel, a track-pad, a track-ball, voice recognition software and the like, depending on the requirements and implementation of the user device 104 and of the academic program advisory system 110. The communication component of the user device 104 can also include an interface that enables the user device 104 to communicate with the academic program advisory system 110.

The network 102 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the academic program advisory system 110, the user device 104 and the external data storage 108.

The external data storage 108 can store data similar to that of the data storage 114. For example, the external data storage 108 can store the data models used by the academic program advisory system 110 and/or information related to, but not limited to, the users of the academic program advisory system 110, academic institutions, academic programs and/or types of employments. The external data storage 108 can, for example, be a network attached storage (NAS) or a cloud storage. The data stored in the external data storage 108 can be retrieved by the academic program advisory system 110 via the network 102.

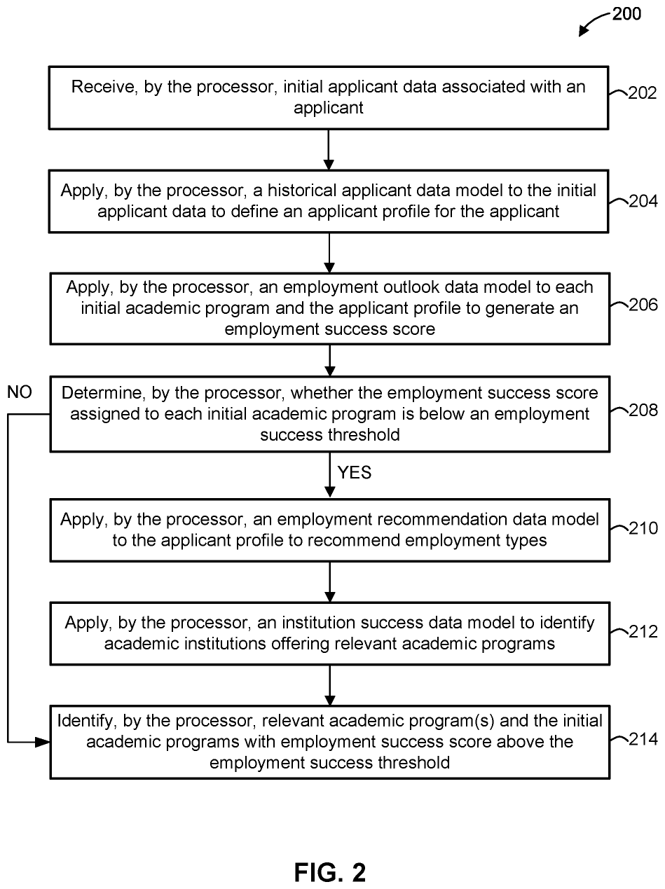

Reference is now made to FIG. 2, which shows a flowchart 200 of an example operation of the academic program advisory system 110 to automatically recommend one or more academic programs for an applicant.

At 202, the processor 112 receives an initial applicant data associated with the applicant.

The initial applicant data can include various information related to the applicant, such as, but not limited to, personal information related to the applicant and/or academic programs identified by the applicant. The initial applicant data can include information that may affect the applicant's eligibility for admission into an academic program and academic institution. When considering academic institutions or academic programs in foreign jurisdictions, the applicant's eligibility may vary depending on their country of residence or education. Example applicant data can include, but is not limited to, the applicant's nationality, past or current education country (including main language of education), education level, grading scheme of their education country, grades (e.g., grade point average (GPA)), English exam type where relevant and type of study permit or visa that has already been obtained or in progress of being obtained (and associated status of visa or permit application). Other applicant data can include age, country of residence, gender, whether the applicant is seeking to enroll into an academic term or a seasonal session (e.g. a summer program), any gap years taken by the applicant, the semester or timeframe to which the applicant is seeking admission, the academic program level, tuition budget, standardized test scores, program level (e.g., Bachelor, Masters, Post Doctorate, etc.), program progression (whether the applicant is interested in programs that are considered a progression from their current program level) and the applicant's language skills.

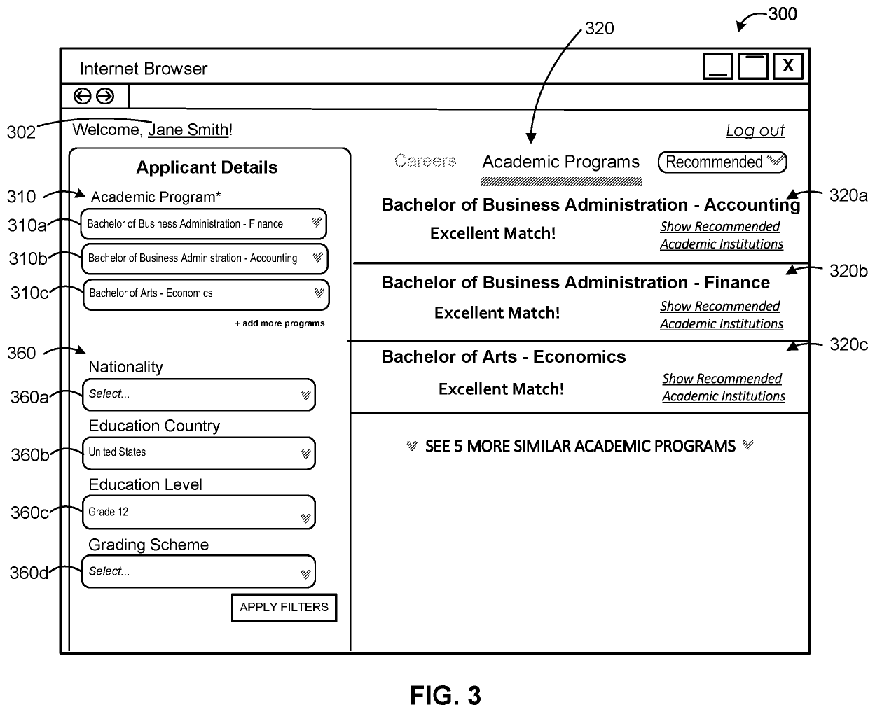

Briefly, FIG. 3 shows an example user interface 300 from which the academic program advisory system 110 can receive at least some of the initial applicant data. For example, the academic program advisory system 110 can receive one or more academic programs 310 of interest (in the example of FIG. 3, the academic programs 310 of interest can be selected from a dropdown list). Additional academic programs 310 of interest can be entered, as shown in FIG. 3. In this illustrated example, the applicant 302, Jane Smith, is interested in the academic program 310 “Bachelor of Business Administration—Finance” 310a, “Bachelor of Business Administration—Accounting” 310b, and “Bachelor of Arts—Economics” 310c. The user interface 300 also includes data fields for receiving other personal data 360 in respect of the applicant 302. For example, the data fields for receiving the personal data 360 can include, but not limited to, a nationality field 360a, an education country field 360b, an education level field 360c, and a grading scheme field 360d. The example other personal data fields 360 shown in FIG. 3 are only for illustrative purposes and are not intended to limit the scope of the personal data 360 that can be received by the academic program advisory system 110.

At 204, the processor 112 applies a historical applicant data model to the initial applicant data to define an applicant profile for the applicant 302.

As described, the academic program advisory system 110 can train a historical applicant data model using historical applicant information to define one or more different predefined applicant profiles for representing past applicant information. Each predefined applicant profile can relate to one or more past applicants with similar characteristics. For example, one predefined applicant profile can relate to one or more past applicants with an education background in Hong Kong and top grades according to a particular grading scheme. Another example predefined applicant profile can relate to past applicants having attended institutions where English is not the primary language of instruction and seeking post-secondary education in North America. Other predefined applicant profiles can be based on different characteristics of the applicants, as required by the academic program advisory system 110.

It is possible for additional applicant data to be received during usage of the academic program advisory system 110. When the additional applicant data is received, the processor 112 applies the historical applicant data model to the additional applicant data and the initial applicant data to update the applicant profile. The resulting recommendations generated by the academic program advisory system 110 may then vary accordingly.

By applying the historical applicant data model to the applicant data to generate the applicant profile, the academic program advisory system 110 is able to qualify the applicant against a global metric. It is often difficult for academic institutions to consider applicants from different education backgrounds as education systems vary between countries and even within countries. The grading systems can also vary significantly between countries, and the way in which schools within the same jurisdiction assigns grades can also be different as the educators may grade against different scales.

The academic program advisory system 110 can then apply the historical applicant data model to the initial applicant data to characterize that applicant with respect to the predefined applicant profiles. For example, the academic program advisory system 110 can determine from applying the historical applicant data model to the initial applicant data how closely the initial applicant data relates to one or more predefined applicant profiles. The academic program advisory system 110 can then define an applicant profile for the applicant 302 by assigning a profile match score to one or more of the predefined applicant profiles. Generally, when the academic program advisory system 110 assigns a high profile match score to a predefined applicant profile based on the initial applicant data, the resulting applicant profile is very similar to that predefined applicant profile, whereas when academic program advisory system 110 assigns a low profile match score based on the initial applicant data, the resulting applicant profile is not very similar to that predefined applicant. The profile match score can be represented in different ways, such as but not limited to, numerically or a descriptive label or representation. The profile match score may, in some embodiments, not be displayed to the applicant or user of the academic program advisory system 110. The academic program advisory system 110 can limit the applicant profile to be defined with respect to only the predefined applicant profiles assigned a profile match score that exceeds a profile score threshold. It is possible that the initial applicant data may have similar profile match scores to multiple predefined applicant profiles, or the initial applicant data may not be associated with any of the predefined applicant profiles sufficiently (e.g., the resulting profile match score does not exceed the profile score threshold).

At 206, the processor 112 applies an employment outlook data model to each initial academic program 310 (received at 202) and to the applicant profile defined at 204 to generate an employment success score for the applicant 302 in that initial academic program 310.

As briefly described, the academic program advisory system 110 (or an external system) can train an employment outlook data model to characterize relationships between an academic program 310 and a likelihood of employment following completion of that academic program 310, as well as, in some embodiments, the type of employment. The academic program advisory system 110 can train the employment outlook data model based on employment results of past applicants, or students who have completed the associated academic program but not necessarily applicants who used the academic program advisory system 110. The employment outlook data model can be trained to consider the applicant profile when generating the employment success score for the applicant 302 in that initial academic program so that the employment success score takes into consideration the characteristics of the applicant 302.

The employment success score can represent the likelihood that the applicant 302 will obtain a relevant employment type following completion of the academic program 310a being considered. Continuing with the example shown in FIG. 3, the academic program advisory system 110 can apply the employment outlook data model to determine the employment success score of the applicant 302 once each of the academic programs 310a to 310c is completed. Generally, when the academic program advisory system 110 assigns a high employment success score to the academic program 310, there is high employment likelihood, whereas when academic program advisory system 110 assigns a low employment success score, there is low employment likelihood. The employment success score can be represented in different ways, such as but not limited to, numerically or with a descriptive label or representation. The employment success score may, in some embodiments, not be displayed to the applicant or user of the academic program advisory system 110.

At 208, for each initial academic program 310, the processor 112 determines whether the employment success score (generated at 206 for that initial academic program 310) is below an employment success score threshold.

The employment success score threshold corresponds to a tolerance acceptable by the applicant 302 when selecting between the academic programs 310. The employment success score threshold may be predefined by the academic program advisory system 110 or may be adjusted by the applicant 302 depending on the tolerance level desired. A change in the employment success score threshold could trigger the processor 112 to repeat step 208 with respect to the changed employment success score threshold. In some embodiments, the academic program advisory system 110 may determine the employment success score is 80% for the applicant 302 after completing the academic program 310a, which is above an employment success score threshold defined as 60%. It will be understood that other threshold values and representations may be used.

Continuing with the example in FIG. 3, the academic program advisory system 110 may determine that the employment success score for the applicant 302 is high for each of the academic programs 310a to 310c, and sufficiently satisfies the employment success score threshold, which can be represented in different ways, such as but not limited to, numerical representations. As shown in FIG. 3, each of the initial academic programs 310a to 310c is considered an “Excellent Match” and is listed in the recommended academic programs 320 as corresponding recommended academic programs 320a to 320c.

When the academic program advisory system 110 determines that all the academic program(s) 110 are associated with an employment success score above the employment success score threshold, the method 200 proceeds to 214. However, when the academic program advisory system 110 determines any of the academic program(s) 110 is associated with the employment success score below the employment success score threshold, the method 200 proceeds to 210.

At 214, the processor 112 identifies the relevant academic program(s) and/or the initial academic program(s) 310 associated with the employment success score above the employment success threshold as the recommended academic program(s) 320 for the applicant 302.

In the example of FIG. 3, the academic program advisory system 110 determined that the initial academic programs 310a to 310c are associated with the employment success score above the employment success threshold and has provided them as respective recommended academic programs 320a to 320c. The academic program advisory system 110 then provides options to identify academic institutions that offer these recommended academic programs 320a to 320c.

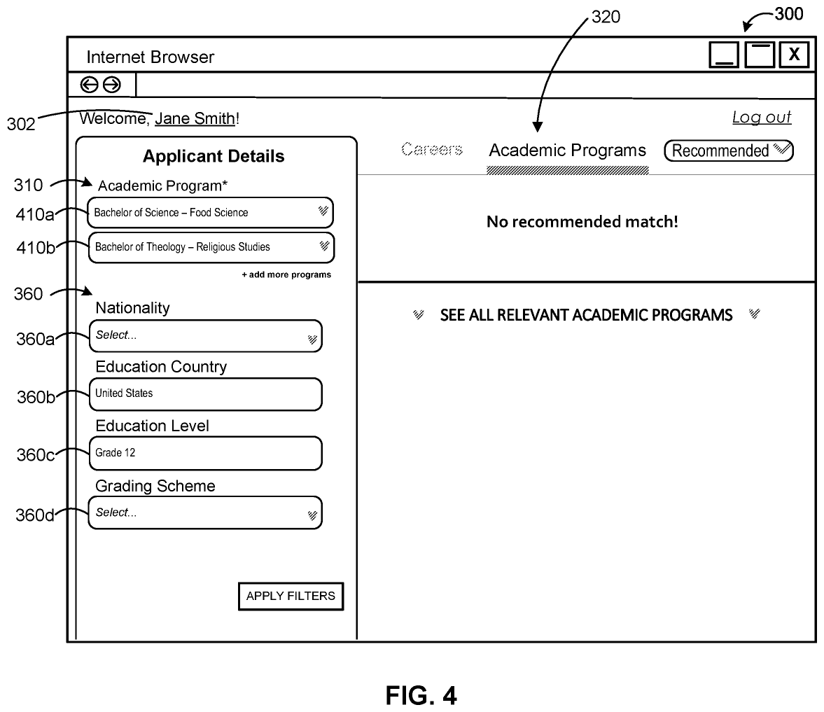

FIG. 4 shows the user interface 300 when different initial academic programs 310 are provided to the academic program advisory system 110. In this example, the applicant 302 selects “Bachelor of Science—Food Science” as the initial academic program 410a and “Bachelor of Theology—Religious Studies” as the initial academic program 410b. As can be seen in FIG. 4, the academic program advisory system 110 was unable to identify any recommended academic programs 320 assigned the employment success score above the employment success threshold.

In some embodiments, the academic program advisory system 110 may rank the recommended academic programs 320. The academic program advisory system 110 may rank the recommended academic programs 320 on the associated employment success scores and/or an acceptance likelihood. For example, if two different academic programs are associated with the same, or substantially similar, employment success scores, they may then be ranked by the academic program advisory system 110 in accordance with the applicant's acceptance likelihood.

The academic program advisory system 110 may determine the applicant's acceptance likelihood by applying an acceptance data model to the initial applicant data. The acceptance data model can be trained on historical acceptance data, such as the acceptance rate of each applicant (beyond the applicants using the academic program advisory system 110) applying to each academic program, as well as the characteristics of each applicant (e.g., based on applicant profiles that may be available for each applicant or generated by the academic program advisory system 110).

Returning to FIG. 2, at 210, in response to determining that at least one of the initial academic programs 310 is associated with an employment success score that is below the employment success threshold, the processor 112 applies an employment recommendation data model to the applicant profile (defined at 204) to recommend employment types(s) for the applicant 302.

As briefly described, the academic program advisory system 110 (or other system) can train the employment recommendation data model using past applicant or student (those who did not apply for the academic program through the academic program advisory system 110) information and their resulting employment types to assist with offering employment type recommendations to the applicant 302. The employment recommendation data model can be applied to the applicant profile to recommend employment types with which similar applicants or students have found employment success.

The processor 112 may, in some embodiments, apply the employment recommendation model to the initial academic programs 310 identified by the applicant 302 so that the recommendations on employment types can take into consideration the applicant's academic programs 310 of interest.

In some embodiments, the employment recommendation data model can assign an employment match score to the initial employment types identified for the applicant 302. The academic program advisory system 110 may then only select to display to the applicant 302 the initial employment types assigned the employment match score that is above an employment match threshold.

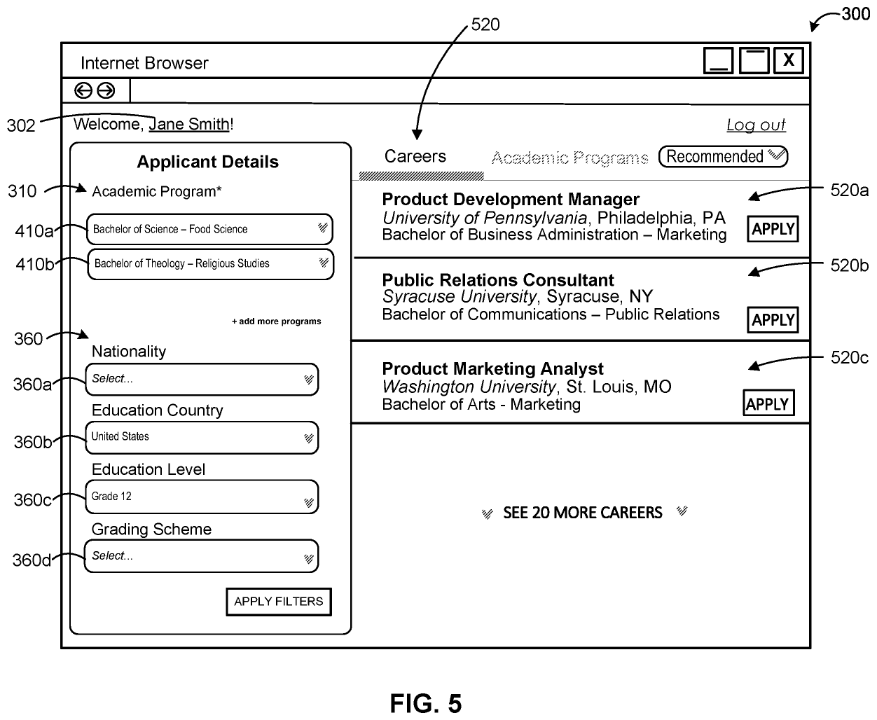

For example, with reference to FIGS. 4 and 5, the academic program advisory system 110 determined that the initial academic programs 410a and 410b were assigned the employment success score below the employment success threshold. The academic program advisory system 110 can then apply the employment recommendation data model to the applicant profile generated for the applicant 302 and the initial academic programs 410a and 410b to recommend employment types(s). From the employment recommendation data model, it can be determined that the employment types 520 shown in FIG. 5 may be appropriate for the applicant 302, such as “Product Development Manager” employment type 520a, “Public Relations Consultant” employment type 520b and “Product Marketing Analyst” employment type 520c.

In some embodiments, the academic program advisory system 110 may also apply the employment recommendation data model to identify similar employment types to those recommended to the applicant 302 and/or those selected by the applicant 302. In some embodiment, the processor 112 may display the employment success score associated with each of the initial academic programs 310 and request additional applicant data from the applicant 302 prior to applying the employment recommendation data model.

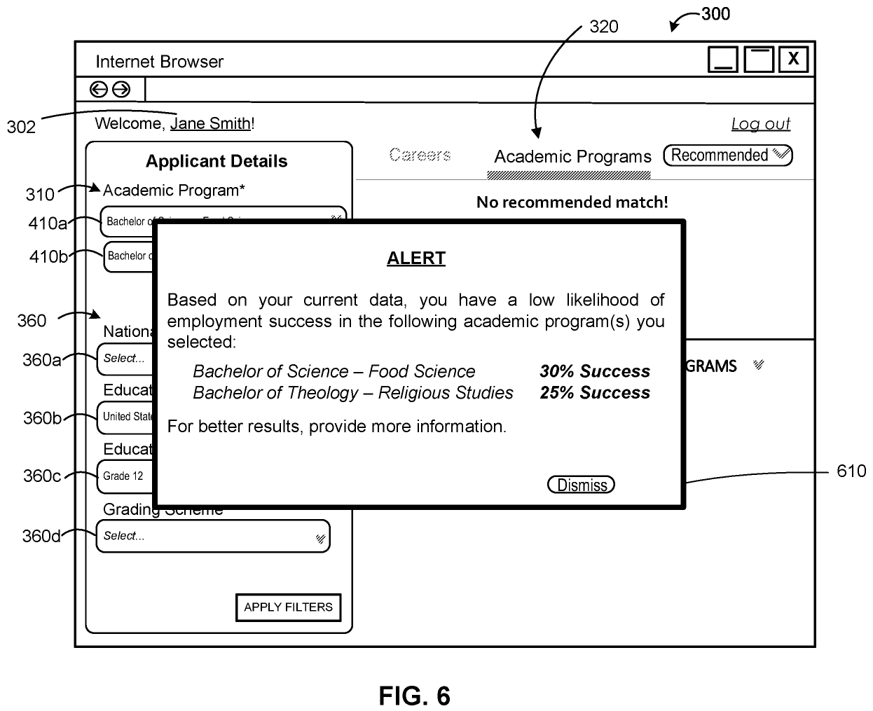

Reference will now be made to FIG. 6, which continues from the example shown in FIG. 4. The academic program advisory system 110 can display an alert window 610 advising the user that at least one of the initial academic programs 410a and 410b was assigned the employment success score that is below the employment success threshold. In this case, the initial academic program 410a was assigned the employment success score of 30% and the initial academic program 410b was assigned the employment success score of 25%. The academic program advisory system 110 can then prompt the applicant 302 to provide further information to improve the employment success score and/or the recommendations offered by the academic program advisory system 110.

At 212, the processor 112 applies an institution success data model to each employment type recommended at 210 and the applicant profile defined at 204 to identify academic institution(s) that offer the relevant academic program(s). The institution success data model is trained on historical data related to each academic institution's overall success in preparing their students in the associated academic program(s) for the employment type in question. Although many academic institutions offer similar academic programs, the academic institutions may not necessarily be preparing their students well for the associated employment type. The curriculum and instructors, for example, at the academic institutions will vary and so, the resulting education received by the students may not be sufficient to prepare the students for the employment type. As a result, the institution success data model can identify relationships between each academic institution's likelihood in enabling their students to employment success in the associated employment types. The institution success data model may also be trained on other related data including, but not limited to, the acceptance rate of that academic institution, and/or the availability of co-op programs or internships.

In some embodiments, the processor 112 can apply the institution success data model to each initial academic program 310 to identify academic institutions offering that initial program with a program success score above a program success threshold. For example, the processor 112 can apply the institution success data model to initial academic programs which are associated with an employment success score that is above the employment success threshold. The program success score can relate to an employment success following completion of the initial academic program at that initial academic institution. Accordingly, the processor 112 can apply the institution success data model to each initial academic program 310 to identify one or more institutions offering that initial academic program, determine a program success score for each institution identified, and identify the one or more institutions that have a program success score above a program success threshold. For example, continuing with the example shown in FIG. 5, the institution success data model can determine that the academic institution, University of Pennsylvania, has a higher program success score offering the Bachelor of Business Administration—Marketing” academic program than the academic institution, Washington University in offering the similar academic program “Bachelor of Arts—Marketing”.

In some embodiments, the processor 112 may identify academic programs that are similar to the initial academic program(s) identified by the applicant and/or the recommended academic program(s) 320 recommended by the academic program advisory system 110 by applying a similar program data model. The similar program data model can be trained on historical data associated with academic programs that are commonly considered together by an applicant and/or academic programs that academic institutions or advisors have commonly identified as related for an applicant's consideration. The similar program data model may also be trained on data related to a past or current applicant's interactions with the academic program advisory system 110. Other factors the similar program data model may be trained on may include, but are not limited to, similarity in the names of the academic programs, similarity in the descriptions of the academic programs, the length of the academic programs, the application fees, the tuition fees, the average cost of living for students attending the academic institutions, the rank of the academic institutions, the geographic location of the academic institutions, the number of students and of international students studying at the academic institutions, the age of the academic institutions, the availability of co-op programs, the education levels, the number of academic programs of each type offered by the academic institutions, the grade requirements of the academic institutions, and the standardized language test scores requirements of the academic institutions.

In some cases, to offer the applicant 302 the similar program recommendation(s), the academic program advisory system 110 may display an option for the applicant 302 to view similar programs.

Continuing from 212, the processor 112 proceeds to 214 to identify the relevant academic program(s) and/or the initial academic program(s) 310 assigned the employment success score above the employment success threshold as the recommended academic program(s) 320 for the applicant 302. That is, the academic program advisory system 110 can recommend academic programs from the initial academic programs 310 identified by the applicant 302 as well as the relevant academic programs identified by the academic program advisory system 110 at 212 as long as the academic programs have been assigned the employment success score above the employment success threshold.

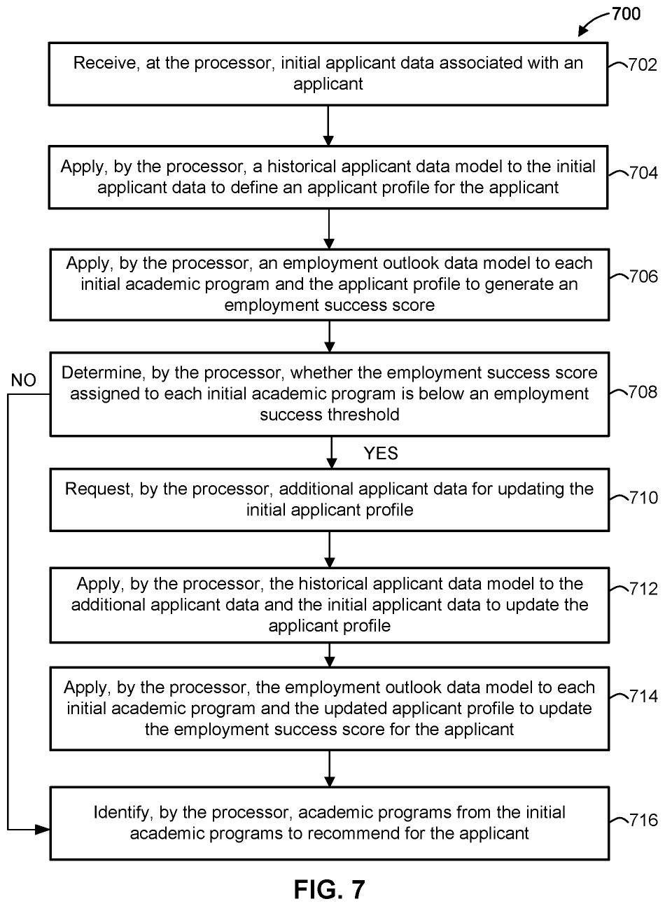

Reference is now made to FIG. 7, which shows a flowchart 700 of another example operation of the academic program advisory system 110 to automatically recommend one or more academic programs for the applicant 302.

At 702, the processor 112 receives an initial applicant data associated with the applicant 302. As described, the initial applicant data can include various information related to the applicant 302, such as, but not limited to, personal information related to the applicant 302 and/or academic programs identified by the applicant 302.

At 704, the processor 112 applies the historical applicant data model to the initial applicant data to define an applicant profile for the applicant 302.

As described, the academic program advisory system 110 can apply the historical applicant data model to the initial applicant data to characterize that applicant 302 with respect to the predefined applicant profiles.

At 706, the processor 112 applies the employment outlook data model to each initial academic program received at 702 and to the applicant profile defined at 704 to generate an employment success score for the applicant 302 in that initial academic program 310. As described, the employment success score can represent the likelihood that the applicant 302 will obtain a relevant employment type following completion of the academic program 310 being considered.

At 708, for each initial academic program 310, the processor 112 determines whether the employment success score (generated at 706 for that initial academic program 310) is below an employment success score threshold. As described, the employment success score threshold corresponds to a tolerance acceptable by the applicant 302 when selecting between the academic programs 310. The employment success score threshold may be predefined by the academic program advisory system 110 or may be adjusted by the applicant 302 depending on the tolerance level desired.

At 710, in response to determining that at least one of the initial academic programs 310 is associated with the employment success score below the employment success threshold, the processor 112 requests additional applicant data from the applicant 302 to update the initial applicant profile.

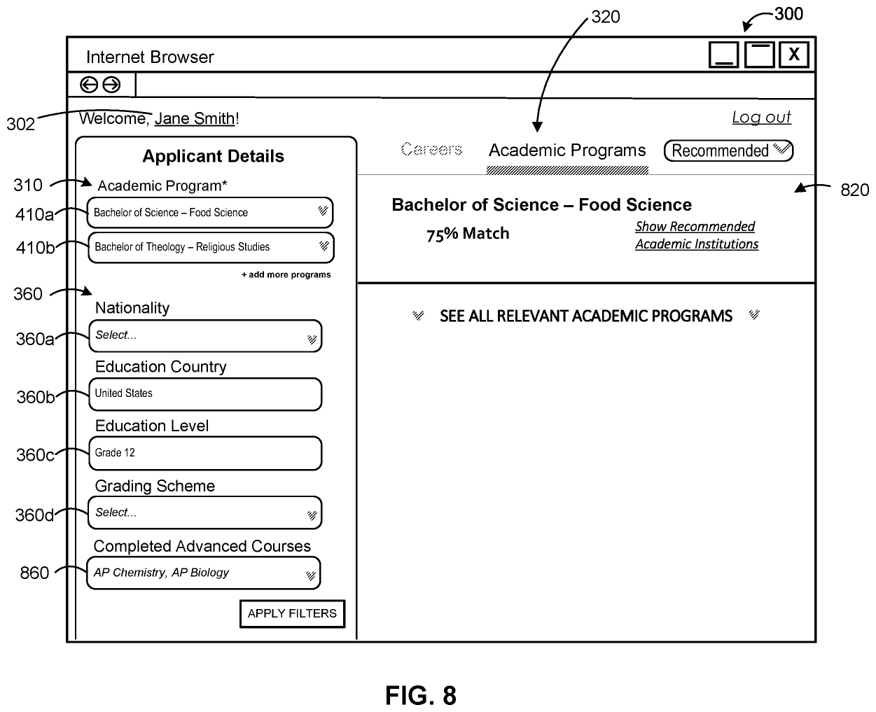

For example, referring again to FIG. 6, the academic program advisory system 110 can display the alert window 610 advising the user that at least one of the initial academic programs 410a and 410b was assigned the employment success score that is below the employment success threshold. In this case, the initial academic program 410a was assigned the employment success score of 30% and the initial academic program 410b was assigned the employment success score of 25%. The academic program advisory system 110 can then prompt the applicant 302 for the additional applicant data. Continuing to FIG. 8, the personal data 360 now includes another data field related to completed advanced courses 860 which indicates that the applicant 302 has completed “AP Chemistry” and “AP Biology”.

In some embodiments, the academic program advisory system 110 may determine specific applicant data relevant to the initial academic programs 310 is absent from the initial applicant data and can then request that specific applicant data from the applicant 302. For example, the academic program advisory system 110 can determine common differences between the applicants who enjoy employment success and applicants who do not enjoy employment success and identify at least some of those differences as crucial applicant data for improving the employment success of the applicant. Continuing with the example in FIG. 8, the academic program advisory system 110 can determine that a key characteristic in applicants who have enjoyed employment success in the academic program 410a is early interest in sciences and prompt the applicant 302 to provide some evidence of this, such as completed advanced courses 860 in sciences. In another example, the academic program advisory system 110 can determine requirements of the initial academic programs 310 are absent from the initial applicant data, such as minimal GPA or language exam scores, and request the applicant data necessary to satisfy those requirements.

At 712, the processor 112 applies the historical applicant data model to the additional applicant data 860 and the initial applicant data to update the applicant profile defined at 704. With the additional applicant data 860, the historical applicant data model may be able to improve the characterization of the applicant 302 with respect to the various predefined applicant profiles when generating the updated applicant profile, thereby improving the employment success score associated with the initial academic programs 310.

At 714, the processor 112 applies the employment outlook data model to each initial academic program 310 and the updated applicant profile defined at 712 to update the employment success score for the applicant 302 in that initial academic program 310. In the example shown in FIG. 8, it can be seen that the additional data field 860 related to the completed advanced courses has significantly improved the employment success score for the applicant 302 (e.g., from 30% to 75%). This example improvement in employment success score is only for illustrative purpose. It will be understood that the employment success score will depend on a number of factors and may not necessarily improve with only the addition of this example additional data and/or only one additional data field.

At 716, the processor 112 identifies one or more academic programs 320 from the one or more initial academic programs 310 to recommend to the applicant 302 based on the employment success score. As can be seen in FIG. 8, the academic program advisory system 110 has identified the recommended academic program 820 for the applicant 302.

In some embodiments, the academic program advisory system 110 may determine that none of the initial academic programs 310 is associated with the employment success score above the employment success threshold. To recommend one or more academic programs for the applicant 302, the academic program advisory system 110 can identify acceptable initial academic programs from the initial academic programs 310 by identifying those academic programs associated with an acceptable employment success score. The acceptable employment success score can be predefined by the academic program advisory system 110 as a minimal score for an academic program that would result in a recommendation for the applicant 302. The acceptable employment success score may be varied by the user (e.g., agent of the applicant 302 or the applicant 302). In the case where the acceptable employment success score cannot be satisfied, the academic program advisory system 110 can request further applicant data from the applicant for updating the applicant profile in order to offer recommendations.

In some embodiments, the academic program advisory system 110 may determine a likelihood for the applicant 302 to receive a foreign permit for studying at a specific foreign jurisdiction by applying a foreign permit data model.

The academic program advisory system 110 may train the foreign permit data model based on historical data related to past applicants receiving the foreign permit for various foreign jurisdictions. The historical data related to the past applicants can include, but not limited to, country of residence, country of citizenship, a desired jurisdiction for education, and/or a level of study. The foreign permit data model can be generated using various machine learning techniques, such as but not limited to, a random forest model. In some embodiments, the applicant profile generated by the academic program advisory system 110 can already take include consideration the likelihood for the applicant 302 to receive the foreign permit for certain jurisdictions and the resulting recommendations may exclude those jurisdictions or rank those jurisdictions as low.

The academic program advisory system 110 may also apply the foreign permit data model to the initial applicant data to provide recommendations for improving the likelihood for the foreign permit to be granted for the applicant 302.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

1. An academic program advisory system for automatically recommending one or more academic programs for an applicant, the system comprising a processor configured to:
receive, from the applicant, an initial applicant data comprising one or more initial academic programs;
apply a historical applicant data model to the initial applicant data to define an applicant profile for the applicant, the applicant profile associating the applicant to one or more predefined applicant profiles defined by the historical applicant data model;
apply an employment outlook data model to each initial academic program and the applicant profile to generate an employment success score for the applicant in that initial academic program;
determine whether the employment success score assigned to each initial academic program is below an employment success threshold;
in response to determining that an initial academic program is associated with the employment success score below the employment success threshold,
apply an employment recommendation data model to the applicant profile to recommend one or more recommended employment types for the applicant; and
apply an institution success data model to each recommended employment type and the applicant profile to identify one or more academic institutions offering one or more relevant academic programs for preparing the applicant for that recommended employment type,
identify at least one of the one or more relevant academic programs and the one or more initial academic programs associated with the employment success score above the employment success threshold as the one or more academic programs recommended for the applicant.

2. The system of claim 1, wherein the processor is further configured to:
apply the historical applicant data model to assign the applicant a profile match score with each predefined applicant profile of the one or more predefined applicant profiles; and
define the applicant profile based on the one or more predefined applicant profiles assigned the profile match score above a profile score threshold.

3. The system of claim 1, wherein the processor is further configured to, in response to determining that the initial academic program is associated with the employment success score below the employment success threshold:
display the employment success score associated with each initial academic program to the applicant;
request additional applicant data from the applicant prior to applying the employment recommendation data model to recommend the one or more recommended employment types for the applicant; and
apply the historical applicant data model to the additional applicant data and the initial applicant data to update the applicant profile.

4. The system of claim 1, wherein the processor is further configured to:
apply the employment recommendation data model to determine the one or more recommended employment types by assigning an employment match score to one or more initial employment types based at least on the applicant profile; and
select the one or more initial employment types assigned the employment match score above an employment match threshold as the one or more recommended employment types.

5. The system of claim 1, wherein the processor is further configured to:
apply the employment recommendation data model to the applicant profile and the one or more initial academic programs to recommend the one or more recommended employment types for the applicant.

6. The system of claim 1, wherein the processor is further configured to:
apply the institution success data model to each initial academic program to identify one or more initial academic institutions offering that initial academic program with a program success score above a program success threshold.

7. The system of claim 6, wherein the program success score relates to an employment success following completion of the initial academic program at that initial academic institution.

8. The system of claim 1, wherein the processor is further configured to:
continuously receive further applicant data from the applicant; and
automatically update the recommended one or more academic programs for the applicant.

9. The system of claim 1, wherein the initial applicant data comprises personal data related to the applicant.

10. A method for automatically recommending one or more academic programs for an applicant, the method comprising operating a processor to:
receive, from the applicant, an initial applicant data comprising one or more initial academic programs;
apply a historical applicant data model to the initial applicant data to define an applicant profile for the applicant, the applicant profile associating the applicant to one or more predefined applicant profiles defined by the historical applicant data model;
apply an employment outlook data model to each initial academic program and the applicant profile to generate an employment success score for the applicant in that initial academic program;
determine whether the employment success score assigned to each initial academic program is below an employment success threshold;
in response to determining that an initial academic program is associated with the employment success score below the employment success threshold,
apply an employment recommendation data model to the applicant profile to recommend one or more recommended employment types for the applicant; and
apply an institution success data model to each recommended employment type and the applicant profile to identify one or more academic institutions offering one or more relevant academic programs for preparing the applicant for that recommended employment type,
identify at least one of the one or more relevant academic programs and the one or more initial academic programs associated with the employment success score above the employment success threshold as the one or more academic programs recommended for the applicant.

11. The method of claim 10 further comprising operating the processor to:
apply the historical applicant data model to assign the applicant a profile match score with each predefined applicant profile of the one or more predefined applicant profiles; and
define the applicant profile based on the one or more predefined applicant profiles assigned the profile match score above a profile score threshold.

12. The method of claim 10 further comprising operating the processor to, in response to determining that the initial academic program is associated with the employment success score below the employment success threshold:
display the employment success score associated with each initial academic program to the applicant;
request additional applicant data from the applicant prior to applying the employment recommendation data model to recommend the one or more recommended employment types for the applicant; and
apply the historical applicant data model to the additional applicant data and the initial applicant data to update the applicant profile.

13. The method of claim 10 further comprising operating the processor to:
apply the employment recommendation data model to determine the one or more recommended employment types by assigning an employment match score to one or more initial employment types based at least on the applicant profile; and
select the one or more initial employment types assigned the employment match score above an employment match threshold as the one or more recommended employment types.

14. The method of claim 10 further comprising operating the processor to:
apply the employment recommendation data model to the applicant profile and the one or more initial academic programs to recommend the one or more recommended employment types for the applicant.

15. The method of claim 10 further comprising operating the processor to:
apply the institution success data model to each initial academic program to identify one or more initial academic institutions offering that initial academic program with a program success score above a program success threshold.

16. The method of claim 15, wherein the program success score relates to an employment success following completion of the initial academic program at that initial academic institution.

17. The method of claim 10 further comprising operating the processor to:
continuously receive further applicant data from the applicant; and
automatically update the recommended one or more academic programs for the applicant.

18. The method of claim 10, wherein the initial applicant data comprises personal data related to the applicant.

19. An academic program advisory system for automatically recommending one or more academic programs for an applicant, the system comprising a processor configured to:
receive, from the applicant, an initial applicant data comprising one or more initial academic programs;
apply a historical applicant data model to the initial applicant data to define an applicant profile for the applicant, the applicant profile associating the applicant to one or more predefined applicant profiles defined by the historical applicant data model;
apply an employment outlook data model to each initial academic program and the applicant profile to generate an employment success score for the applicant in that initial academic program;
determine whether the employment success score assigned to each initial academic program is below an employment success threshold;
in response to determining that an initial academic program is associated with the employment success score below the employment success threshold,
request additional applicant data from the applicant for updating the initial applicant profile;
apply the historical applicant data model to the additional applicant data and the initial applicant data to update the applicant profile; and
apply the employment outlook data model to each initial academic program and the updated applicant profile to update the employment success score for the applicant in that initial academic program; and
identify one or more academic programs from the one or more initial academic programs to recommend to the applicant based on the employment success score.

20. The system of claim 19, wherein the processor is further configured to:
identify the one or more initial academic programs associated with the employment success score above an employment success threshold as the one or more academic programs recommended for the applicant.

21. The system of claim 19, wherein the processor is further configured to:
in response to determining that none of the one or more initial academic programs is associated with the employment success score above the employment success threshold, identify one or more acceptable initial academic programs from the one or more initial academic programs as the one or more academic programs recommended for the applicant, the one or more acceptable initial academic programs being the one or more initial academic programs associated with an acceptable employment success score, otherwise, requesting further applicant data from the applicant for updating the applicant profile.

22. The system of claim 19, wherein the processor is further configured to:
determine one or more application data relevant to the one or more initial academic programs that is absent from the initial applicant data; and
include the one or more application data in the additional applicant data requested from the applicant.

23. The system of a claim 19, wherein the processor is further configured to:
display the employment success score associated with each initial academic program to the applicant.

24. (canceled)

25. (canceled)

26. (canceled)

27. (canceled)

28. (canceled)
